(19) United States
(12) Patent Application Publication
(10) Pub. No.: US 2025/0028147 A1
(43) Pub. Date: Jan. 23, 2025

(54) DRIVING MECHANISM

(71) Applicant: TDK TAIWAN CORP., Taoyuan City (TW)

(72) Inventors: Hsueh-Ju LU, Taoyuan City (TW); Shu-Shan CHEN, Taoyuan City (TW); Ming Hsien SHEN, Taoyuan City (TW); Hui-Chuan TANG, Taoyuan City (TW)

(21) Appl. No.: 18/778,074

(22) Filed: Jul. 19, 2024

Related U.S. Application Data
(60) Provisional application No. 63/514,958, filed on Jul. 21, 2023.

(51) Int. Cl. G02B 7/08; G02B 27/64

(52) U.S. Cl. CPC G02B 7/08; G02B 27/646

(57) ABSTRACT

A driving mechanism is provided, which includes a fixed portion, a movable portion, a driving assembly, and a control assembly. The movable portion is movable relative to the fixed portion. The driving assembly is used for driving the movable portion to move. The control assembly is used for providing control signal to the driving assembly.

### CROSS REFERENCE TO RELATED APPLICATIONS

This Application claims priority of U.S. Provisional Patent Application No. 63/514,958 filed on Jul. 21, 2023, the entirety of which is incorporated by reference herein.

### BACKGROUND OF THE INVENTION

### Field of the Invention

The present disclosure relates to a driving mechanism.

### Description of the Related Art

As technology has developed, it has become more common to include image-capturing and video-recording functions into many types of modem electronic devices, such as smartphones and digital cameras. These electronic devices are used more and more often, and new models have been developed that are convenient, thin, and lightweight, offering more choice to consumers.

Electronic devices that have image-capturing or video-recording functions normally include a driving mechanism to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

A driving mechanism is provided in some embodiments, which includes a fixed portion, a movable portion, a driving assembly, and a control assembly. The movable portion is movable relative to the fixed portion. The driving assembly is used for driving the movable portion to move. The control assembly is used for providing control signal to the driving assembly.

In some embodiments, the control assembly includes a fourth computation unit. The fourth computation unit provides a second determination information based on a difference information or a first intermediate information and a correction information. The driving assembly is used for driving the movable portion to move in a first dimension or a second dimension.

In some embodiments, the correction information includes a first correction information and a second correction information respectively corresponding to the first dimension and the second dimension. The first dimension and the second dimension are different. The first correction information and the second correction information are different.

In some embodiments, the fourth computation unit selects the first correction information or the second correction information based on a status information and a correction database of the correction information. The status information is related to the status of the driving mechanism.

In some embodiments, the correction database includes the first correction information and the second correction information that are different for corresponding to different statuses. The correction database is defined and measured by an external apparatus.

In some embodiments, the fourth computation unit selects either the first correction information or the second correction information based on the difference information or the first intermediate information. When the driving mechanism is in a first state, the first correction information is greater than the second correction information, and a first difference is between the first correction information and the second correction information.

In some embodiments, when the driving mechanism is in a second state, the first correction information is greater than the second correction information, and a second difference is between the first correction information and the second correction information. The first difference and the second difference are different. When the driving mechanism is in a third state, the first correction information is less than the second correction information. When the driving mechanism is in a fourth state, the first correction information is equal to the second correction information.

In some embodiments, a maximum ratio of the first correction information and the second correction information is greater than 2. The first correction information when the driving mechanism is in the first state is different from the first correction information when the driving mechanism is in the second state.

In some embodiments, the driving mechanism receives a first environmental force when the driving mechanism is in the first state. The driving mechanism receives a second environmental force when the driving mechanism is in the second state.

In some embodiments, a direction of the first environmental force relative to the driving mechanism is different from a direction of the second environmental force relative to the driving mechanism. Components of the first environmental force and the second environmental force in a moving direction of the movable portion are different.

In some embodiments, the driving mechanism further includes an inertial sensor disposed on the fixed portion or the movable portion. The first dimension is a movement along a first axis. An angle between the first environmental force and the first axis is different from an angle between the second environmental force and the first axis.

In some embodiments, the status information includes a gravity direction. The status information is provided by the inertial sensor. The status information includes an acceleration information of the driving mechanism.

In some embodiments, the control assembly further includes a first computation unit used for comparing a target information and a current information to provide the difference information, a sensing element used for providing the current information based on a state of the movable portion, and a second computation unit used for comparing the difference information and a permissible information to provide a first determination information.

In some embodiments, the target information is provided by a control center.

In some embodiments, the control assembly further includes a third computation unit. The third computation unit is used for comparing the difference information and a maximum control information to provide a first intermediate information to the fourth computation unit.

In some embodiments, when the difference information is within a range of the maximum control information, the difference information is the first intermediate information. When the difference information exceeds the range of the maximum control information, an extreme value of the maximum control information is the first intermediate information.

In some embodiments, the control assembly further includes a fifth computation unit providing a driving signal to the driving assembly based on the first determination information and the second determination information.

In some embodiments, when the difference information is within a range of the permissible information, the driving signal is a stable signal. When the difference information is within the range of the permissible information, the sensing element continuously provides the current information based on the movable portion. When the difference information exceeds the range of the permissible information, the fifth computation unit provides the driving signal based on the second determination information, and the driving signal is different from the stable signal at this moment.

In some embodiments, the stable signal is 0. A state of the movable portion is unchanged when the driving assembly does not move the movable portion.

In some embodiments, the movable portion stays at any position within a movable range when the driving assembly does not drive the movable portion. The driving mechanism further includes a clamping assembly, and the movable portion stays at any position within the movable range through the clamping assembly. The driving assembly includes piezoelectric material.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic view of a driving mechanism in some embodiments of the present disclosure.

FIG. 2 is a schematic view of some elements of the driving mechanism.

FIG. 3 is a schematic view of the movable portion relative to the fixed portion when the driving assembly is controlled by a control assembly.

FIG. 4 is a schematic view of the driving mechanism in a first state.

FIG. 5 is a schematic view of the driving mechanism in a second state.

FIG. 6 is a schematic view of the driving mechanism in a third state.

FIG. 7 is a schematic view of the driving mechanism in a fourth state.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

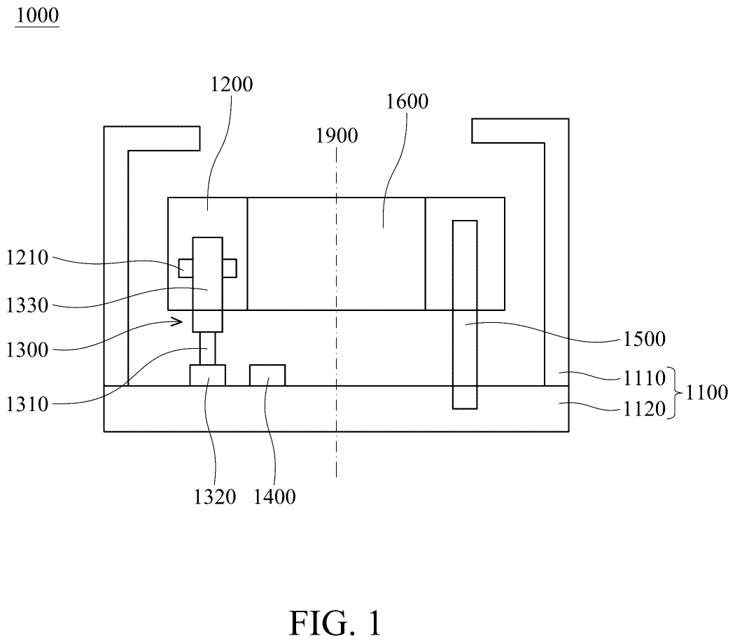

Embodiments of the present disclosure disclose a driving mechanism used for driving an optical element to move. For example, FIG. 1 is a schematic view of a driving mechanism 1000 in some embodiments of the present disclosure. As shown in FIG. 1, the driving mechanism 1000 may mainly include a fixed portion 1100 (which includes a case 1110 and a bottom 1120), a movable portion 1200, a clamping assembly 1210, a driving assembly 1300 (which includes a driving element 1310, a stabilization element 1320, and a transmission element 1330), a control assembly 1400, and a guiding element 1500 used for driving an optical element 1600 to move.

In some embodiments, the optical element 1600 may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the case 1110 and the bottom 1120 may be combined to form a shell of the driving mechanism 1000. Other elements of the driving mechanism 1000 may be disposed in the shell to protect these elements. The optical element 1600 may be disposed on the movable portion 1200, and the movable portion 1200 may be movably connected to the fixed portion 1100 through the driving assembly 1300 and the guiding element 1500.

In some embodiments, the driving assembly 1300 may be used for driving the movable portion 1200 to move relative to the fixed portion 1100 along a first axis 1900. In some embodiments, the driving element 1310 may be formed by piezoelectric material. In other words, when an electric field (voltage) is applied on the surface of the driving element 1310, the electric dipole moment of the driving element 1310 may be elongated. The driving element 1310 will extend along the direction of the electric field to resist change. Therefore, electrical energy may be converted as mechanical energy. In some embodiments, electrical field may along the first axis 1900 be applied to the driving element 1310 to change the length of the driving element 1310 along the first axis 1900 (such as lengthen or shorten).

In some embodiments, an end of the driving element 1310 may be connected to the stabilization element 1320, and the stabilization element 1320 may be disposed on the fixed portion 1100 (such as the bottom 1120). The material of the stabilization element 1320 may include metal (such as iron, copper, etc.) to balance the force that the driving assembly 1300 applied to the fixed portion 1100 when the driving assembly 1300 is in operation. The transmission element 1330 may be connected to another end of the driving element 1310 to transfer the energy to the movable portion 1200 when the driving element 1310 is deforming. The transmission element 1330 may include material that has a smooth surface, such as carbon (e.g. graphite), but it is not limited thereto.

In some embodiments, the clamping assembly 1210 may be, for example, a spring. The clamping assembly 1210 may be affixed on the movable portion 1200 and may press the transmission element 1330 in a pressing direction to ensure that the transmission element 1330 is positioned closely against the movable portion 1200. The transmission element 1330 is movably disposed on the clamping assembly 1210, such as being disposed on the clamping assembly 1210 by friction contact. When the driving element 1310 deforms, if the force applied between the clamping assembly 1210 and the transmission element 1330 exceeds the maximum static friction force between the clamping assembly 1210 and the transmission element 1330, the transmission element 1330 may be moved relative to the clamping assembly 1210 in the extension direction of the transmission element 1330. For example, it can move along the first axis 1900, thereby driving the movable portion 1200 to move relative to the fixed portion 1100 along the first axis 1900. Conversely, if the force applied between the clamping assembly 1210 and the transmission element 1330 is less than the maximum static friction force between the clamping assembly 1210 and the transmission element 1330 when the driving element 1310 deforms, there will be no relative movement between the clamping assembly 1210 and the transmission element 1330.

In some embodiments, the driving element 1310 can be repeatedly deformed back and forth to continuously move the movable portion 1200 in a specific direction. For example, the deformation speed of the driving element 1310 in the specific direction may be increased by applying a higher current to the driving element 1310, and then the deformation speed of the driving element 1310 in the opposite direction may be reduced by applying a lower reverse current. As a result, the driving element 1310 and the clamping assembly 1210 only move relative to each other in this specific direction, and do not move relative to each other in the opposite direction, thereby accumulating the distance moved, which causes the movable portion 1200 moving along the first axis 1900 towards or away from the bottom 1120.

In some embodiments, the control assembly 1400 maybe used to control the driving assembly 1300 and may include various electronic elements. In some embodiments, the driving assembly 1300, the control assembly 1400, and other external devices may be electrically connected via a circuit board (not shown) mounted on the fixed portion 1100 or circuits (not shown) embedded within the fixed portion 1100.

In some embodiments, the guiding element 1500 may have a columnar shape and may extend along the first axis 1900, thus being parallel to the transmission element 1330. In some embodiments, the guiding element 1500 may be fixed to either the fixed portion 1100 or the movable portion 1200 and may move relative to the other to define the moving direction of the movable portion 1200 relative to the fixed portion 1100. In some embodiments, the driving assembly 1300 and the guiding element 1500 may be arranged on opposite sides or opposite corners of the movable portion 1200 to balance the forces applied by the elements on the movable portion 1200.

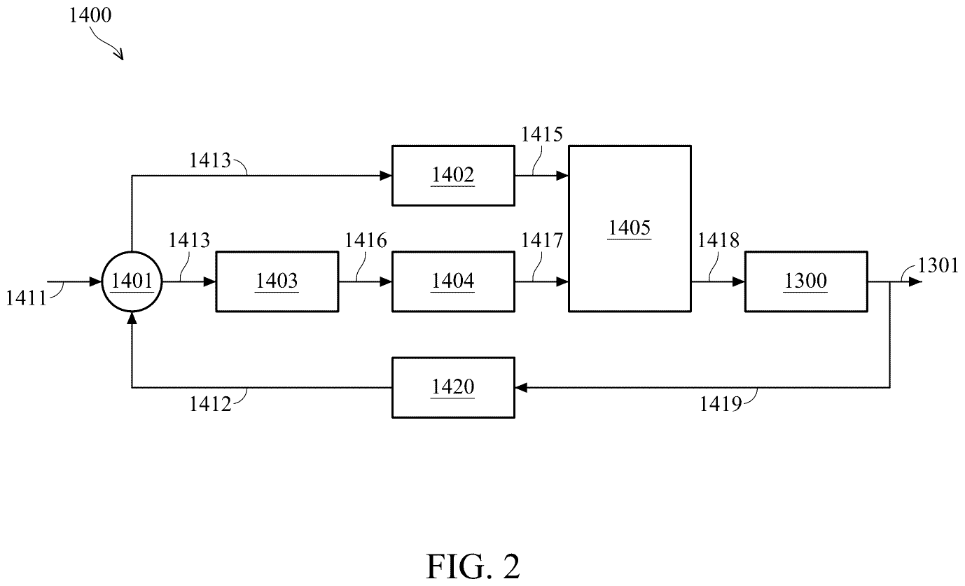

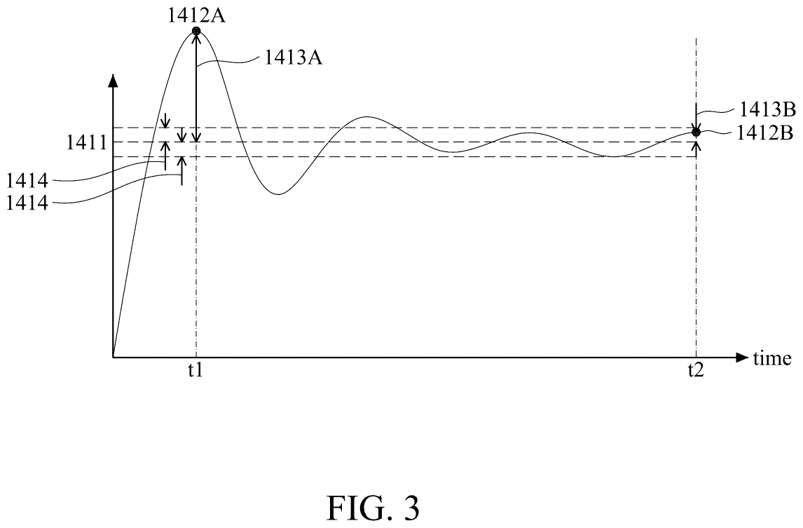

In some embodiments, FIG. 2 is a schematic view of some elements of the driving mechanism 1000, which mainly shows the driving assembly 1300 and the control assembly 1400. FIG. 3 is a schematic view of the stroke of the movable portion 1200 relative to the fixed portion 1100 when the driving assembly 1300 is controlled by the control assembly 1400.

As shown in FIG. 2 and FIG. 3, in some embodiments, the control assembly 1400 may include a first computation unit 1401 used for comparing a target information 1411 and a current information 1412, thereby providing the difference information 1413. In some embodiments, the target information 1411 may include information about the target position of the movable portion 1200 relative to the fixed portion 1100, and the target position may be provided by a control center. For example, when the driving mechanism 1000 is installed on a mobile phone, the control center may be the phone's processor, which provides the target information 1411 to the first computation unit 1401 of the control assembly 1400.

In some embodiments, the control assembly 1400 also includes a sensing element 1420 used for sensing the state of the movable portion 1200, such as the position of the movable portion 1200 relative to the fixed portion 1100, to provide the current information 1412 to the first computation unit 1401. For example, the sensing element 1420 may be disposed on the fixed portion 1100, and the movable portion 1200 may have a reference element (not shown), such as one with magnetic properties. When the movable portion 1200 moves relative to the fixed portion 1100, the magnetic field of the reference element relative to the sensing element 1420 may change to allow the sensing element 1420 determine the position of the movable portion 1200 relative to the fixed portion 1100. Moreover, this information may be recorded in the current information 1412 to provide to the first computation unit 1401.

In some embodiments, the sensing element 1420 may include a Hall sensor, a magnetoresistance effect sensor (MR sensor), a giant magnetoresistance effect sensor (GMR sensor), a tunneling magnetoresistance effect sensor (TMR sensor), or a fluxgate sensor.

In some embodiments, the operation of obtaining the difference information 1413 from the target information 1411 and the current information 1412 may include calculating the difference value between the target information 1411 and the current information 1412. For example, the difference information 1413 may be the value obtained by subtracting the current information 1412 from the target information 1411. Afterwards, the first computation unit 1401 provides the difference information 1413 to the second computation unit 1402 and the third computation unit 1403 for performing different operations.

In some embodiments, as shown in FIG. 2 and FIG. 3, the second computation unit 1402 may compare the difference information 1413 with a permissible information 1414 to provide a first determination information 1415. In some embodiments, the permissible information 1414 may be a preset threshold, and based on whether the difference information 1413 falls within the range of the permissible information 1414, the second computation unit 1402 may provide a different first determination information 1415. For example, if the difference information 1413 (which includes the difference between the target position and the current position of the movable portion 1200) falls within the range of the permissible information 1414, it is determined that the movable portion 1200 has been driven to the desired position. Conversely, if the difference information 1413 falls outside the range of the permissible information 1414, it is determined that the movable portion 1200 has not been driven to the desired position, and this determination result is recorded in the first determination information 1415. For example, at the time t1 in FIG. 3, the difference between the current information 1412A and the target information 1411 is a difference information 1413A, and since the difference information 1413A falls outside the range of the permissible information 1414, it is determined that the movable portion 1200 has not been driven to the desired position, and thus driving may continue. In some embodiments, the ratio of the permissible information 1414 to the target information 1411 may be less than 0.05, but it is not limited thereto.

In some embodiments, the third computation unit 1403 may be used for comparing the difference information 1413 with a maximum control information to provide the first intermediate information 1416 to the fourth computation unit 1404. When the difference information 1413 falls within the range of the maximum control information, the difference information 1413 is the first intermediate information 1416. When the difference information 1413 exceeds the range of the maximum control information, a first extreme value of the maximum control information is the first intermediate information 1416.

Specifically, the maximum control information may include the maximum stroke information of the driving assembly 1300 during a single operation, and the third computation unit 1403 may control the maximum stroke of the driving assembly 1300 during a single operation. After accumulating multiple operations, the movable portion 1200 may be moved to the target position. For example, if the difference between the current position and the target position of the movable portion 1200 recorded in the difference information 1413 is less than the range of the maximum control information, the third computation unit 1403 may directly provide this difference information 1413. If the difference between the current position and the target position of the movable portion 1200 recorded in the difference information 1413 is greater than the range of the maximum control information, the third computation unit 1403 will control the stroke of this movement within the maximum stroke range, and the first extreme value is this maximum stroke. Therefore, the maximum stroke of the driving assembly 1300 during a single operation may be controlled.

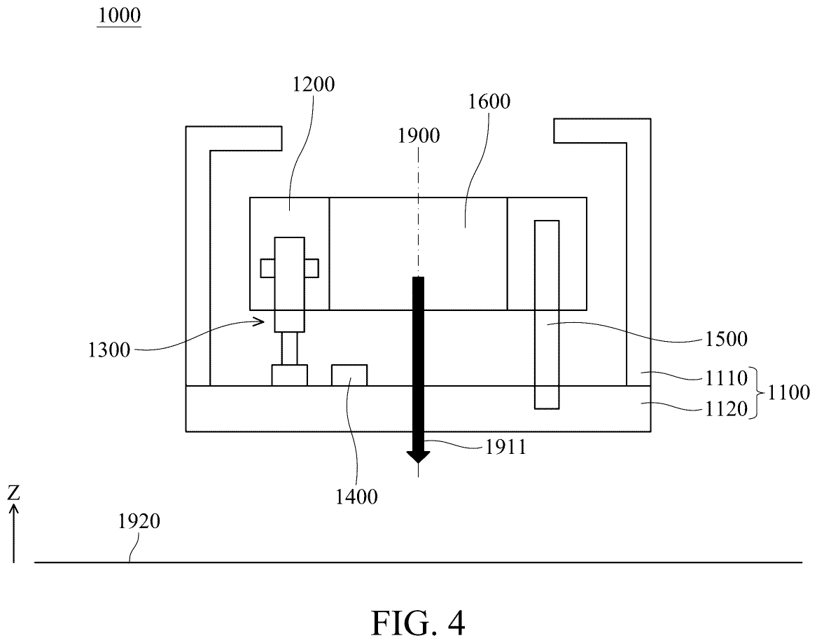

FIG. 4 is a schematic view of the driving mechanism 1000 in a first state. In some embodiments, when the driving mechanism 1000 operates, it may be affected by external forces, such as the direction of the driving mechanism 1000, gravity direction, sudden acceleration of the environment, user jitter, etc. Therefore, when the driving assembly 1300 drives the movable portion 1200 along the first axis 1900 toward and away from the bottom 1120, the external force on the driving mechanism 1000 will vary. For example, when the first axis 1900 is perpendicular to the horizontal plane 1920, the first environmental force 1911 applied on the driving mechanism 1000 may be parallel to the first axis 1900 and may be directed toward the −Z direction.

Therefore, when the driving assembly 1300 moves in different directions (e.g., towards from or away from the bottom 1120), the required driving force will be different. For example, the movement of the movable portion 1200 away from the bottom 1120 on the first axis 1900 (+Z direction) may be defined as a first dimension, and the movement of the movable portion 1200 towards the bottom 1120 (−Z direction) may be defined as a second dimension. The driving assembly 1300 may be used for driving the movable portion 1200 to move in the first dimension and the second dimension, and the first dimension and the second dimension are different. In other embodiments, the first dimension and the second dimension may also include movement, rotation, or other types of motion in different axes.

In some embodiments, the fourth computation unit 1404 may be used for determining the dimension in which the movable portion 1200 is currently moving (such as determining based on external status information) and may select different correction information based on the status information. For example, the status information may relate to the state of the driving mechanism 1000, such as the direction of acceleration, the direction of gravity, sudden environmental acceleration, vehicle movement, user shaking, etc. The correction information may include a first correction information and a second correction information, which correspond to the first dimension and the second dimension, respectively. In some embodiments, this status information may be measured by an inertial sensor (not shown).

When the movable portion 1200 moves in the first dimension, the fourth computation unit 1404 may provide the first correction information. When the movable portion 1200 moves in the second dimension, the fourth computation unit 1404 may provide the second correction information. The first correction information and the second correction information are different. Thus, different parameters may be used for control during movements in different dimensions, thereby offsetting the influence of external forces (e.g., the first environmental force 1911) on the driving mechanism 1000. Therefore, problems such as long settling time or oscillations when the driving mechanism 1000 moving in specific directions may be prevented.

In some embodiments, when the driving mechanism 1000 is in different states, i.e., having different status information, the fourth computation unit 1404 may select suitable first correction information and second correction information from the correction database in the correction information. In some embodiments, the motion state of the driving mechanism 1000 may be measured by an external apparatus during the production of the driving mechanism 1000, thus defining a suitable correction database for the driving mechanism 1000. This may balance the influence of external forces on the driving mechanism 1000.

For example, when the driving assembly 1300 is controlled by proportional control, the first correction information and the second correction information may be the proportional gain for the movement of the movable portion 1200 along the first dimension and the second dimension, respectively. However, the present disclosure is not limited thereto, and the first correction information and the second correction information may also represent other control coefficients when other methods are used to control the driving assembly 1300. In some embodiments, the fourth computation unit 1404 may also select either the first correction information or the second correction information based on the difference information 1413 or the first intermediate information 1416.

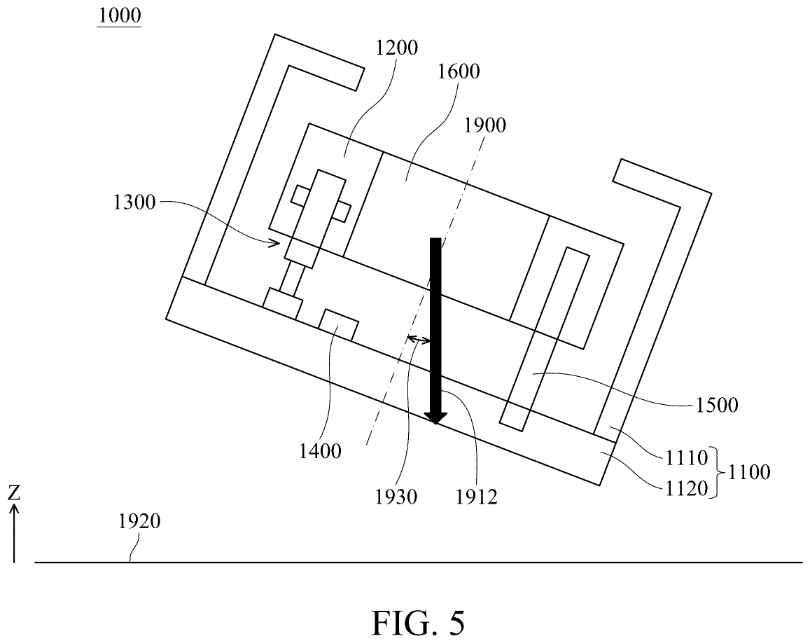

As shown in FIG. 4, when the driving mechanism 1000 is in the first state, such as when the first axis 1900 extends in the +Z direction and is perpendicular to the horizontal plane 1920, the first correction information is greater than the second correction information, and a first difference is between the first correction information and the second correction information. Next, FIG. 5 is a schematic view of the driving mechanism 1000 in a second state, where the first axis 1900 is neither perpendicular nor parallel to the horizontal plane 1920 but has an inclined angle to the horizontal plane 1920. At this moment, the driving mechanism 1000 is subjected to a second environmental force 1912 with an angle 1930 greater than zero between the second environmental force 1912 and the first axis 1900, and the angle 1930 between the second environmental force 1912 and the first axis 1900 is different from the angle (e.g., 0 degrees) between the first environmental force 1911 and the first axis 1900. The first environmental force 1911 and the second environmental force 1912, for example, can be gravity and have different directions relative to the driving mechanism 1000, so that the components of the first environmental force 1911 and the second environmental force 1912 in the moving direction of the movable portion 1200 are different.

The driving mechanism 1000 is in the second state at this moment, and the first correction information is greater than the second correction information. A second difference is between the first correction information and the second correction information, and the second difference is different from the first difference. For example, the maximum ratio of the first correction information to the second correction information may be greater than 2, such as greater than 4. In some embodiments, the first correction information when the driving mechanism 1000 is in the first state of FIG. 4 and the first correction information when the driving mechanism 1000 is in the second state of FIG. 5 may be different from each other. Therefore, suitable first correction information and second correction information may be selected to control the driving assembly 1300 in a more precise way.

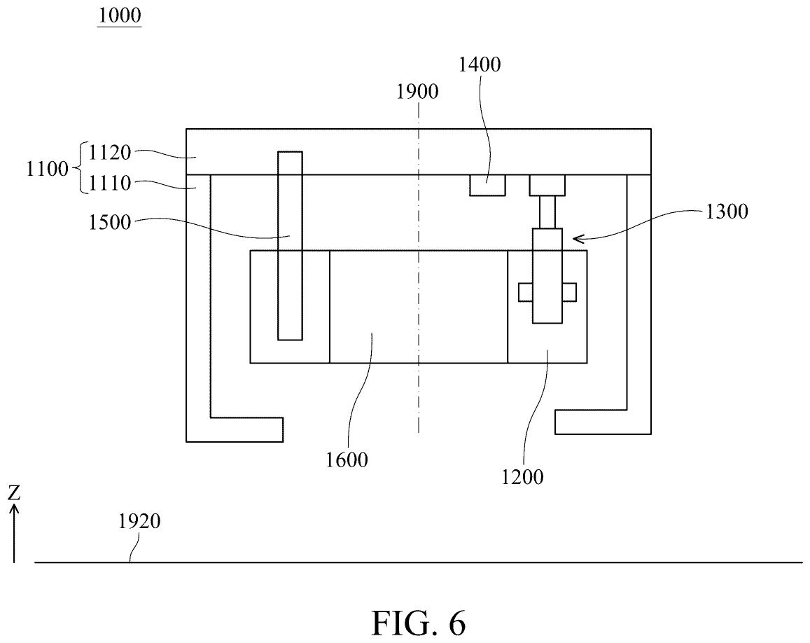

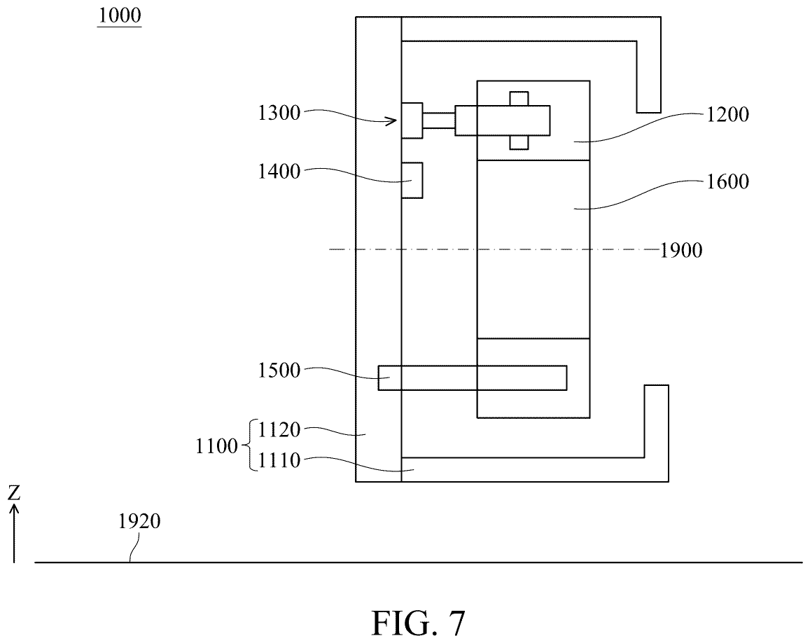

FIG. 6 and FIG. 7 are schematic views of the driving mechanism 1000 in the third state and the fourth state, respectively. The third state may be the state when the driving mechanism 1000 in the first state is rotated 180 degrees, and the fourth state may be the state when the driving mechanism 1000 in the first state is rotated 90 degrees. In the third state, the first correction information may be smaller than the second correction information. In the fourth state, the first correction information may be equal to the second correction information. As a result, influence caused by external forces (e.g., gravity) applied on the driving mechanism 1000 may be balanced, and thus achieves more precise control results.

Referring back to FIG. 2 and FIG. 3, the first correction information or the second correction information selected by the fourth computation unit 1404 may be called as a second determination information 1417. The second computation unit 1402 provides the first determination information 1415 to the fifth computation unit 1405, and the fourth computation unit 1404 also provides the second determination information 1417 to the fifth computation unit 1405. Afterwards, the fifth computation unit 1405 provides a driving signal 1418 to the driving assembly 1300 based on the first determination information 1415 and the second determination information 1417, thereby providing a driving force 1301 to the movable portion 1200 via the driving assembly 1300 for driving the movable portion 1200.

When the difference information 1413 is within the range of the permissible information 1414, the driving signal 1418 may be a stable signal, such as a constant value or zero. For example, at a time t2 in FIG. 3, the difference between the current information 1412B and the target information 1411 is a difference information 1413B, and the difference information 1413B falls within the range of the permissible information 1414. At this moment, the driving assembly 1300 has driven the movable portion 1200 to the desired position, and power supply to the driving assembly 1300 may be stopped. Since the clamping assembly 1210 holds the transmission element 1330 of the driving assembly 1300, the movable portion 1200 may remain in any desired position and angle within the movable range, even after power provided to the driving assembly 1300 is stopped, so functions such as auto focus (AF) may be achieved.

Conversely, when the difference information 1413 exceeds the range of the permissible information 1414, such as at the time t1 in FIG. 3, the difference information 1413A exceeds the range of the permissible information 1414. At this time, the fifth computation unit 1405 may provide the driving signal 1418 based on the second determination information 1417, and the driving signal 1418 at this time (e.g., not 0) is different from the stable signal at the time t2 (e.g., 0). Therefore, the movable portion 1200 may be moved relative to the fixed portion 1100 and may allow the movable portion 1200 to reach the target position.

It should be noted that regardless of whether the driving signal 1418 is 0, regardless of whether the driving assembly 1300 is operating, and regardless of whether the difference information 1413 is within the range of the permissible information 1414, the sensing element 1420 will continuously detect the state of the movable portion 1200 relative to the fixed portion 1100 to obtain the sensing information 1419 and continuously provide the current information 1412. In other words, even if the movable portion 1200 has been driven to the desired position, the sensing element 1420 will continue detect the position of the movable portion 1200. If external forces cause unwanted movement of the movable portion 1200, the sensing element 1420 may immediately detect it and respond accordingly, such as moving the movable portion 1200 to the desired position, thereby achieving auto focus and optical image stabilization (OIS).

In summary, a driving mechanism is provided, which includes a fixed portion, a movable portion, a driving assembly, and a control assembly. The movable portion is movable relative to the fixed portion. The driving assembly is used for driving the movable portion to move. The control assembly is used for providing control signal to the driving assembly. Additionally, different correction information may be provided for the movable portion when moving in different dimensions, thereby allowing the driving mechanism to adapt to various environmental conditions for more precise control.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. A driving mechanism, comprising:
a fixed portion;
a movable portion movable relative to the fixed portion;
a driving assembly used for driving the movable portion to move; and
a control assembly used for providing a control signal to the driving assembly.

2. The driving mechanism as claimed in claim 1, wherein the control assembly comprises a fourth computation unit;
wherein:
the fourth computation unit provides a second determination information based on a difference information or a first intermediate information and a correction information;
the driving assembly is used for driving the movable portion to move in a first dimension or a second dimension.

3. The driving mechanism as claimed in claim 2, wherein:
the correction information comprises a first correction information and a second correction information respectively corresponding to the first dimension and the second dimension;
the first dimension and the second dimension are different;
the first correction information and the second correction information are different.

4. The driving mechanism as claimed in claim 3, wherein:
the fourth computation unit selects the first correction information or the second correction information based on a status information and a correction database of the correction information;
the status information is related to the status of the driving mechanism.

5. The driving mechanism as claimed in claim 4, wherein:
the correction database comprises the first correction information and the second correction information that are different for corresponding to different statuses;
the correction database is defined and measured by an external apparatus.

6. The driving mechanism as claimed in claim 5, wherein:
the fourth computation unit selects either the first correction information or the second correction information based on the difference information or the first intermediate information;
when the driving mechanism is in a first state, the first correction information is greater than the second correction information, and a first difference is between the first correction information and the second correction information.

7. The driving mechanism as claimed in claim 6, wherein:
when the driving mechanism is in a second state, the first correction information is greater than the second correction information, and a second difference is between the first correction information and the second correction information;
the first difference and the second difference are different;
when the driving mechanism is in a third state, the first correction information is less than the second correction information;
when the driving mechanism is in a fourth state, the first correction information is equal to the second correction information.

8. The driving mechanism as claimed in claim 7, wherein:
a maximum ratio of the first correction information and the second correction information is greater than 2;
the first correction information when the driving mechanism is in the first state is different from the first correction information when the driving mechanism is in the second state.

9. The driving mechanism as claimed in claim 8, wherein:
the driving mechanism receives a first environmental force when the driving mechanism is in the first state;
the driving mechanism receives a second environmental force when the driving mechanism is in the second state.

10. The driving mechanism as claimed in claim 9, wherein:
a direction of the first environmental force relative to the driving mechanism is different from a direction of the second environmental force relative to the driving mechanism;
components of the first environmental force and the second environmental force in a moving direction of the movable portion are different.

11. The driving mechanism as claimed in claim 10, further comprising an inertial sensor disposed on the fixed portion or the movable portion, wherein:
the first dimension is a movement along a first axis;
an angle between the first environmental force and the first axis is different from an angle between the second environmental force and the first axis.

12. The driving mechanism as claimed in claim 11, wherein:
the status information comprises a gravity direction;
the status information is provided by the inertial sensor;
the status information comprises an acceleration information of the driving mechanism.

13. The driving mechanism as claimed in claim 3, wherein the control assembly further comprises:
a first computation unit used for comparing a target information and a current information to provide the difference information;
a sensing element used for providing the current information based on a state of the movable portion; and
a second computation unit used for comparing the difference information and a permissible information to provide a first determination information.

14. The driving mechanism as claimed in claim 13, wherein the target information is provided by a control center.

15. The driving mechanism as claimed in claim 14, wherein the control assembly further comprises a third computation unit;
wherein:
the third computation unit is used for comparing the difference information and a maximum control information to provide a first intermediate information to the fourth computation unit.

16. The driving mechanism as claimed in claim 15, wherein:
when the difference information is within a range of the maximum control information, the difference information is the first intermediate information;
when the difference information exceeds the range of the maximum control information, an extreme value of the maximum control information is the first intermediate information.

17. The driving mechanism as claimed in claim 16, wherein the control assembly further comprises a fifth computation unit providing a driving signal to the driving assembly based on the first determination information and the second determination information.

18. The driving mechanism as claimed in claim 17, wherein:
when the difference information is within a range of the permissible information, the driving signal is a stable signal;
when the difference information is within the range of the permissible information, the sensing element continuously provides the current information based on the movable portion;
when the difference information exceeds the range of the permissible information, the fifth computation unit provides the driving signal based on the second determination information, and the driving signal is different from the stable signal at this moment.

19. The driving mechanism as claimed in claim 18, wherein:
the stable signal is 0;
a state of the movable portion is unchanged when the driving assembly does not move the movable portion.

20. The driving mechanism as claimed in claim 19, wherein:
the movable portion stays at any position within a movable range when the driving assembly does not drive the movable portion;
the driving mechanism further comprises a clamping assembly, and the movable portion stays at any position within the movable range through the clamping assembly;
the driving assembly comprises piezoelectric material.
